(19) United States
(12) Patent Application Publication
(10) Pub. No.: US 2009/0032210 A1
(43) Pub. Date: Feb. 5, 2009

(54) Exothermic And Insulating Feeder Sleeves Having A High Gas Permeability

(75) Inventors: Udo Skerdi, Bendorf (DE); Josef Kroth, Muhlheim-Korlich (DE); Henning Rehse, Wermelskirchen (DE)

Correspondence Address: SCOTT R. COX;LYNCH, COX, GILMAN & MAHAN, P.S.C., 500 WEST JEFFERSON STREET, SUITE 2100, LOUISVILLE, KY, 40202, US

(73) Assignee: AS LUNGEN GMBH, Bendorf/Rhein (DE)

(21) Appl. No.: 11/908,651

(22) PCT Filed: Mar. 14, 2006
(86) PCT No.: PCT/EP2006/002329

§ 371 Date: Apr. 16, 2008

(30) Foreign Application Priority Data
Mar. 14, 2005 (DE) 102005011644.2

(51) Int. Cl. B22D 29/00; C04B 35/00; C04B 35/599; C21B 7/16

(52) U.S. Cl. 164/131; 501/127; 501/128; 264/299; 266/265

(57) ABSTRACT

The invention relates to a molding composition for producing insulating or exothermic feeders and other filling funnels and feeding elements for casting molds, which comprises at least:
at least 10% by weight of a porous refractory material which has a continuous open pore structure;
a binder for curing the molding mixture;
if appropriate, a refractory filler;
a proportion of a reactive aluminum oxide having a specific surface area of at least about 0.5 m²/g and an average particle diameter (D₅₀) of from about 0.5 to 8 μm.

The invention further relates to a process for producing a feeder and other filling funnel or feeding elements for casting molds; feeders, filling funnels or feeding elements for casting molds which are obtained by the process and also their use for producing metal castings. The feeders and further shaped bodies for the foundry industry obtained from the molding composition of the invention have a particularly high gas permeability and a low density.

The invention relates to a molding composition for producing shaped bodies for the foundry industry, in particular insulating or exothermic feeders and other filling funnels and feeding elements for casting molds, a process for producing such casting molds for the foundry industry, shaped bodies for the foundry industry, in particular feeders, filling funnels and feeding elements for casting molds, and the use of such shaped bodies for the foundry industry in a process for casting a metal part.

In the production of metal castings in a foundry, liquid metal is introduced into a casting mold. During solidification, the volume of the metal introduced decreases. For this reason, feeders, i.e. open or closed spaces in or on the casting mold, are normally used in order to compensate the volume deficit in the solidification of the casting and to prevent formation of voids in the casting. For this purpose, the feeders are connected to the casting or the region of the casting which is at risk and are normally arranged above or on the side of the hollow space of the mold.

In the production of metal castings, a pattern whose shape corresponds essentially to that of the metal casting to be produced is produced first. Feeding elements and feeders are attached to this pattern. The pattern is subsequently surrounded with molding sand in a mold box. The molding sand is compacted and then cured. After curing, the casting mold is taken from the mold box. The casting mold has a shaped hollow space or, if the casting mold is made up of a plurality of pieces, part of the shaped hollow space which corresponds essentially to a negative of the metal casting to be produced. After the casting mold has, if appropriate, been assembled, liquid metal is introduced into the shaped hollow space of the casting mold. The inflowing liquid metal displaces the air present in the shaped hollow space. The air escapes through the openings provided in the casting mold or through porous sections of the casting mold, for example through the wall of a feeder. The feeders therefore preferably have a sufficient porosity, so that, firstly, the liquid metal can flow into the feeder on introduction of the liquid metal and, secondly, further still liquid metal can flow from the feeder into the shaped hollow space of the casting mold during cooling and solidification of the metal in the shaped hollow space.

EP 0 888 199 B1 describes feeders which can have exothermic properties or insulating properties and are obtained by means of a cold box process. For this purpose, a feeder mixture is introduced into a feeder casting mold. The feeder mixture comprises an oxidizable metal and an oxidant or an insulating refractory material or mixtures of these materials and also an effective amount of a chemically reactive cold box binder. The feeder mixture is shaped to give an uncured feeder which is then brought into contact with a gaseous curing catalyst. The cured feeder can then be taken from the casting mold. As insulating refractory material, it is possible to use hollow aluminum silicate microspheres. The use of such microspheres of aluminum silicate gives the feeders a low thermal conductivity and thus a very pronounced insulating action. Furthermore, these feeders have a very low weight so that they can, firstly, be handled and transported easily and, secondly, do not fall off from the pattern very easily when this is, for example, tilted.

EP 0 913 215 B1 describes a process for producing feeders and other charging and feeding elements for casting molds. For this purpose, a composition which comprises hollow aluminum silicate microspheres having an aluminum oxide content of less than 38% by weight, a binder for cold box curing and, if appropriate, a filler which is not in fibrous form is shaped by blowing into a mold box to give an uncured mold product. This uncured mold product is brought into contact with a suitable catalyst, resulting in curing of the mold product. The cured mold product can then be taken from the mold box. The feeders obtained by this process also have a pronounced insulating action and a low weight.

Although the above-described feeders which comprise hollow aluminum silicate microspheres as refractory filler have a low density and a high insulating action, they have the disadvantage of a relatively low gas permeability. The liquid metal can therefore flow only slowly into the feeders.

WO 00/73236 A2 discloses an exothermic feeder composition which comprises aluminum and magnesium, at least one oxidant, an SiO₂-containing filler and an alkali metal silicate as binder. The feeder composition further comprises from about 2.5 to 20% by weight of a reactive aluminum oxide having a specific surface area of at least about 0.5 m²/g and an average particle diameter (D₅₀) of from about 0.5 to 8 μm. The feeder composition is virtually free of fluoride-containing fluxes. The use of such a feeder composition for producing feeders enabled “hollow firing”, which probably occurs as a result of vitrification of the SiO₂-containing fillers by reaction with alkali metal compounds, to be reduced significantly.

It is known that porous refractory materials, for example pumice, can be added in small proportions to molding compositions for the foundry industry in order to save weight. However, these porous refractory materials are relatively soft and therefore disintegrate very easily under mechanical stress. The proportion of these porous refractory materials in known molding compositions is therefore not more than about 8% by weight, based on the dry weight of the molding composition. If higher proportions of such porous refractory materials are used, severe decreases in the stability of the shaped bodies produced from such molding compositions have to be accepted.

A first object of the invention was to provide a molding composition for producing shaped bodies for the foundry industry, in particular insulating or exothermic feeders and other filling funnels and feeding elements for casting molds, which makes it possible to produce shaped bodies which have a high gas permeability.

This object is achieved by a molding composition for producing shaped bodies for the foundry industry, in particular insulating or exothermic feeders and other filling funnels and feeding elements for casting molds, which has the features of claim 1. Advantageous embodiments of the molding composition are subject matter of the dependent claims.

The molding composition of the invention for producing shaped bodies for the foundry industry, in particular insulating or exothermic feeders and other filling funnels and feeding elements for casting molds, comprises at least:

at least 10% by weight of a porous refractory material which has a continuous open pore structure;
a binder for curing the molding mixture;
if appropriate, a refractory filler;
a proportion of a reactive aluminum oxide having a specific surface area of at least about 0.5 m²/g and an average particle diameter (D₅₀) of from about 0.5 to 8 μm.

The molding composition of the invention contains a relatively high proportion of a porous refractory material which has a continuous open pore structure. As a result of the open-pored structure, the porous refractory materials are permeated by a multiplicity of passages through which a gas can flow. The shaped bodies produced from the molding composition of the invention therefore have a very high gas permeability. It has surprisingly been found that a combination of a porous refractory material which has a continuous open pore structure and therefore a high gas permeability with a reactive aluminum oxide and, if appropriate, a refractory filler makes it possible to obtain a molding composition from which it is possible to produce shaped bodies, in particular feeders, which have a high dimensional accuracy and sufficient strength and, in particular, a very high gas permeability. The proportion of the porous refractory material which has a continuous open pore structure may be increased considerably compared to the amounts previously used. The proportion of the porous refractory material in the molding composition is at least 10% by weight, based on the dry molding composition, preferably at least 15% by weight, particularly preferably at least 20% by weight.

For the purposes of the present invention, a porous refractory material which has a continuous open pore structure is a refractory material having a sponge-like structure which extends through the entire volume of the particle. Such an open-pored structure can be recognized, for example, on a polished section of a particle, if appropriate when enlarged under a microscope. While the hollow microspheres mentioned at the outset each have a single “pore” surrounded by a largely gastight shell and therefore do not allow simple gas exchange between the hollow space of the hollow microsphere and the surroundings, the open-pored refractory material present in the molding composition of the invention is permeated by passages which make gas exchange of the individual pores with the surroundings possible. The proportion of pores in the total volume of the porous open-pored material is preferably very high. The porous refractory material preferably has a pore volume of at least 50%, preferably at least 60%, in particular at least 65%. The pore volume can, for example, be determined by mercury intrusion.

The porous refractory materials having an open-pored structure which are present in the molding composition of the invention preferably have a density of less than 0.5 g/ml, preferably less than 0.4 g/ml, particularly preferably from 0.05 to 0.4 g/ml. The shaped bodies produced from the molding composition of the invention therefore advantageously have a low weight. Feeders produced from the molding composition can, for example, be attached to a pattern and, owing to their low weight, do not fall off when the pattern or the mold is turned.

Furthermore, the porous refractory material used in the molding composition of the invention preferably has a low thermal conductivity. The thermal conductivity of the porous refractory material is preferably 0.04-0.25 W/mK.

Suitable porous refractory materials are, for example, pumice, expanded shale, pearlite, vermiculite, boiler sand, foamed lava and expanded concrete and also mixtures thereof.

Shaped bodies which are produced from the molding composition of the invention display a very high gas permeability. When feeders are produced from the molding composition of the invention, the air present in the casting hollow space can escape through the wall of the feeder when liquid metal is introduced into the casting mold due to the high gas permeability of the feeders, so that the liquid metal can flow without difficulties into the hollow space of the casting mold or the hollow space of the feeders.

The molding composition preferably has a gas permeability index of at least 150, preferably more than 200, in particular more than 300. The gas permeability index is a parameter customarily used in the foundry industry to describe the porosity of shaped bodies or molding sands. It is usually determined in instruments from Georg Fischer A G, Schaffhausen, Switzerland.

The determination of the gas permeability of the porous refractory material is described further below.

For use in the molding composition of the invention, the porous refractory material is milled to a suitable particle size. The suitable particle size can easily be determined by a person skilled in the art by means of trials. The porous refractory material is appropriately milled to an average particle size of less than 1.5 mm, particularly preferably less than 1 mm. The particle size can be set by customary methods, for example by sieving or air classification.

Pumice is particularly preferably used as porous refractory material. Pumice is a naturally occurring vitreous rock, i.e. it has an essentially amorphous structure without discernible crystals. Pumice has a low density of down to about 0.3 g/cm³. It has a very high pore volume of up to 85%. Due to its high porosity, pumice has a very high gas permeability.

The pumice used is preferably a material from a natural source which has been milled to a suitable particle size. The particle size of the milled pumice is preferably less than 1.5 mm, particularly preferably less than 1 mm. The particle size can, for example, be set by sieving or air classification.

The molding composition of the invention may, if appropriate, further comprise a refractory filler. As refractory filler, it is possible to use, for example, aluminum silicates, for example fibrous refractory fillers, or zirconium oxide sand. It is also possible to use synthetic refractory fillers, for example mullite (Al₂SiO₅). The choice of refractory fillers is initially not subject to any restrictions per se.

Furthermore, the molding composition of the invention comprises a proportion of a reactive aluminum oxide.

This has a specific surface area of at least about 0.5 m²/g and an average particle diameter (D₅₀) of from about 0.5 to 8 μm. The reactive aluminum oxide can be obtained by milling aluminum oxide very finely.

The molding composition preferably comprises a refractory filler which has a relatively low proportion of SiO₂. The refractory filler preferably has an SiO₂ content of less than 60% by weight, preferably less than 50% by weight, particularly preferably less than 40% by weight. The low proportion of SiO₂ counters the risk of vitrification, as a result of which casting defects can be avoided. The molding composition of the invention particularly preferably contains no SiO₂ as constituent of the mixture, i.e. is free of, for example, silica sand. The SiO₂ present in the molding composition is thus preferably present in bound form as aluminum silicate.

The refractory filler is particularly preferably made up at least partly of chamotte. For the purposes of the present invention, chamotte is a strongly fired (double-fired) clay which is dimensionally stable up to a temperature of about 1500° C. Apart from proportions of amorphous material, chamotte can contain the crystalline phases mullite (3Al₂O₃.2SiO₂) and cristobalite (SiO₂). The chamotte has likewise preferably been milled to a particle size of less than 1.5 mm, more preferably less than 1 mm. The chamotte gives the shaped bodies produced from the molding composition, in particular feeders, a very high heat resistance and strength.

The proportion of chamotte in the refractory filler is preferably high. The proportion of chamotte, based on the weight of the refractory filler, is preferably at least 50% by weight, particularly preferably at least 60% by weight and very particularly preferably at least 70% by weight. In a particularly preferred embodiment, the refractory filler is formed essentially only by chamotte. The chamotte is preferably present in milled form in the molding composition of invention. The particle size is preferably less than 1.5 mm, particularly preferably less than 1 mm.

The chamotte preferably has a high proportion of aluminum oxide. The chamotte preferably contains at least 30% by weight of aluminum oxide, particularly preferably at least 35% by weight and very particularly preferably at least 40% by weight. The aluminum oxide is preferably present in the form of aluminum silicates.

The proportion of refractory filler, based on the weight of the molding composition, is preferably in the range from 5 to 60% by weight, particularly preferably from 8 to 50% by weight. The proportions of refractory filler do not include the proportions of pumice and reactive aluminum oxide.

The percentages given for the proportions of the individual components of the molding composition are in each case based on the weight of the molding composition in the dry state.

As binders for curing the feeder mixture, it is in principle possible to use any binders. The binder is preferably selected from among cold box binders and water glass. However, hot box binders or resin binders are also possible as binders.

When a cold box binder is used, this is preferably selected from the group consisting of phenol-urethane resins which are activated by amines, epoxy-acrylic resins which can be activated by SO₂, alkaline phenolic resins which can be activated by CO₂ or methyl formate and also water glass which can be activated by CO₂. A person skilled in the art will be familiar with such cold box binders per se. Such binder systems are described, for example, in U.S. Pat. No. 3,409,579 or U.S. Pat. No. 4,526,219.

Particular preference is given to using water glass as binder. As water glass, it is possible to use customary water glasses as are already used as binders in molding material mixtures for the foundry industry. These water glasses contain dissolved sodium or potassium silicates and can be prepared by dissolving vitreous potassium and sodium silicates in water. The water glass preferably has an M₂O/SiO₂ modulus in the range from 2.0 to 3.5, where M is sodium and/or potassium. The water glasses preferably have a solids content in the range from 20 to 50% by weight. Solid water glass is particularly preferably present in the molding composition of the invention. In calculating the proportions in the molding composition, only the solids of the water glass are taken into account in each case.

As further important constituent in addition to the porous refractory material, in particular pumice, the molding composition of the invention contains a proportion of a reactive aluminum oxide. The reactive aluminum oxide preferably has some, particularly preferably all, of the following properties:

Al₂O₃ content >90%
OH group content <5%
Specific surface area (BET) 1 to 10 m²/g
Average particle diameter (D₅₀) 0.5 to 15 μm

The porous refractory material, in particular pumice, present in the molding composition of the invention preferably has a pore volume of at least 50%, preferably at least 70%. The proportion of the pore volume is based on the total volume of the porous refractory material or pumice. The proportion of the porous refractory material, in particular pumice, is made relatively high in the molding composition of the invention. Based on the weight of the molding composition, the proportion of the porous refractory material, in particular pumice, is preferably at least 16% by weight, more preferably at least 18% by weight, particularly preferably at least 20% by weight. In the case of molding compositions for producing exothermic feeders, the proportion of porous refractory material, in particular pumice, in the molding composition of the invention is preferably in the range from 15 to 35% by weight and particularly preferably in the range from 18 to 25% by weight. For the production of insulating shaped bodies, for example insulating feeders, the proportion of pumice can be even higher, for example greater than 50% by weight.

Due to the high porosity of pumice, the molding composition of the invention makes it possible to produce insulating shaped bodies, in particular insulating feeders. However, it is also possible to formulate the molding composition in such a way that it can be used for producing exothermic feeders which ignite on contact with liquid metal and therefore delay the solidification of the metal in the feeder. For this purpose, the molding composition of the invention contains, in one embodiment, an oxidizable metal, in particular aluminum and/or magnesium and/or silicon, and an oxidant. The oxidizable metals and the oxidant are preferably likewise present in finely divided form.

As oxidant, it is possible to use, as in known molding compositions, for example iron oxide and/or an alkali metal nitrate such as sodium or potassium nitrate, with the reaction product of the latter (alkali metal nitrite or alkali metal oxide) reacting with the reactive aluminum oxide.

Apart from the constituents mentioned above, the molding composition can also contain other constituents in customary amounts. Thus, for example, an organic material such as wood flour can be present. The organic material is preferably present in a form in which it does not absorb any liquid constituents such as water glass. For this purpose, the wood flour can, for example, firstly be sealed by means of a suitable material such as water glass so that the pores are closed. The presence of the organic material reduces the cooling of the liquid metal on initial contact with the wall of the shaped body, in particular feeder, produced from the molding composition of the invention.

The molding composition of the invention is preferably virtually free of fluoride-containing fluxes. The fluoride content is preferably less than 1% by weight, more preferably less than 0.5% by weight, particularly preferably less than 0.1% by weight, calculated as sodium fluoride.

The reactive aluminum oxide is preferably present in a proportion of more than 2% by weight, preferably more than 5% by weight, based on the weight of the molding composition, in the molding composition of the invention.

The makeup of the molding composition of the invention can be varied according to requirements. To produce insulating feeders, the amounts of porous refractory material, in particular pumice, refractory filler and reactive aluminum oxide are preferably selected within the following ranges:

| | |
|---|---|
| Refractory porous | 15 to 90% by weight, |
| material (pumice) | preferably from 60 to 80% by weight |
| Refractory filler | 5 to 50% by weight, |
| | preferably from 8 to 20% by weight |
| Reactive aluminum | 5 to 30% by weight, |
| oxide | preferably from 8 to 20% by weight |

If an organic material such as wood flour is present, it is preferably present in a proportion of from 5 to 20% by weight, preferably from 8 to 12% by weight.

In the case of an exothermic molding composition, preferred proportions are:

| | |
|---|---|
| Aluminum | 20 to 35% by weight, |
| | preferably from 25 to 30% by weight |
| Magnesium | 1 to 15% by weight, |
| | preferably from 2 to 10% by weight |
| Oxidant | 8 to 20% by weight, |
| | preferably from 10 to 15% by weight |
| Reactive aluminum | 4 to 20% by weight, |
| oxide | preferably from 10 to 18% by weight |
| Refractory porous | 15 to 40% by weight, |
| material (pumice) | preferably from 20 to 30% by weight |
| Refractory filler | 5 to 30% by weight, |
| | preferably from 8 to 20% by weight |

The invention further provides a process for producing shaped bodies for the foundry industry, in particular insulating or exothermic feeders and other filling funnels and feeding elements for casting molds, which comprises the steps:
introduction of a molding composition as described above into a mold to give an uncured shaped body;
curing of the uncured shaped body to give a cured shaped body; and
removal of the cured shaped body from the mold.

The molding composition of the invention can be processed in the customary way to produce shaped bodies for the foundry industry, giving, for example, feeders, filling funnels or feeding elements for casting molds, which have a very high gas permeability and a very high strength. To keep the losses of binder low, the porous refractory material can also firstly be wetted with a filling liquid which does not have an adverse effect on the setting process, for example water.

To cure the uncured shaped body, it is possible to use customary methods. If a cold box binder is used, curing of the binder is effected by exposure to a suitable catalyst or curing agent in gaseous form. Suitable compounds have been described above. If, for example, a hot box binder is used, curing of the shaped body is effected by heating to a suitable temperature. The structure of hot box binders corresponds essentially to cold box binders. However, they are different in that curing does not occur as a result of addition of a catalyst at comparatively low temperatures. The energy required for curing is instead introduced by heating of the uncured shaped body.

Water glass is preferably used as binder, in which case curing is effected by heating so that the water present in the water glass is evaporated. This can be brought about by, for example, blowing hot air through the shaped body. However, it is also possible to cure the water glass by blowing in carbon dioxide.

The invention further provides a shaped body for the foundry industry, in particular a feeder, filling funnel or feeding element for casting molds, which has been obtained by the above-described process. The shaped bodies have the following advantages:

The gas permeability of the shaped bodies is very high. As a result, typical casting defects can be avoided.

The thermal stability of the shaped bodies is very high since a quartz transition can be avoided.

The shaped bodies according to the invention display only little penetration by the liquid metal introduced into the casting mold.

The shaped bodies, in particular exothermic feeders, can contain a high proportion of magnesium. This reduces the tendency of cast iron to change type, since the formation of lamellar graphite is prevented and the desired formation of spherical graphite is promoted.

The shaped bodies have a low density and can therefore be handled more readily. Feeders in particular can be produced in any shape, including, for example, feeders which are plugged into the pattern. These have to be particularly light since otherwise there is a risk of them falling out on turning the mold.

The shaped bodies have a very high strength which exceeds the strength of shaped bodies produced using hollow aluminum silicate microspheres.

The shaped bodies of the invention have a high insulating action, so that nonexothermic shaped bodies, in particular insulating feeders, can be produced. The shaped bodies offer high strengths and good dimensional stability compared to commercial fiber-containing feeders.

The shaped bodies of the invention, in particular feeders, can also comprise organic materials by means of which cooling on initial contact is additionally reduced, so that the insulating action is increased further.

The shaped bodies of the invention, in particular feeders, filling funnels or feeding elements, have, in particular, a very high gas permeability. The shaped bodies of the invention, in particular feeders, filling funnels or feeding elements, preferably have a gas permeability index of more than 150, preferably more than 200. The determination of the gas permeability index is described below.

The invention further provides for the use of a shaped body, in particular a feeder, filling funnel or feeding element, as described above in a process for casting a metal casting, which comprises the steps:
provision of a pattern in a mold box;
attachment of at least one shaped body, in particular a feeder, filling funnel or feeding element for casting molds, as described above to the pattern;
introduction and compaction and curing of a molding material in the mold box so as to give a casting mold;
removal of the casting mold from the mold box;
introduction of liquid metal into the casting mold;
cooling of the metal to solidify it and give a metal casting; and

removal of the metal casting from the casting mold.

The shaped bodies of the invention can be used in conventional processes for producing casting molds. The casting mold is produced by conventional processes using materials known to those skilled in the art, for example molding sand, as molding material.

The invention is illustrated below with the aid of examples.

### Analytical Methods:

### Determination of the Gas Permeability Index

### a) Production of a Test Specimen:

About 100 g of the porous refractory material to be tested, which has been adjusted to an average particle size of about 0.3 mm, are mixed with 20 g of water glass (solids content about 30%, Na₂O/SiO₂ modulus about 2.5) in a mixer for about 2 minutes. The mixture is introduced into a cylinder having an internal diameter of 50 mm. The cylinder is placed in a Georg-Fischer rammer (Georg Fischer A G, Schaffhausen). The mixture is compacted in the rammer by means of three blows. The cylinder with the compacted molding composition is taken from the rammer and the molding composition is cured by blowing carbon dioxide through the molding composition from the open end of the cylinder for about 3 seconds in each case. The cured test specimen can then be pushed from the cylinder. After the test specimen has been pushed out, its height is measured. This should be 50 mm. If the test specimen does not have the desired height, a further test specimen has to be produced using a modified amount of the molding composition. The test specimen is subsequently dried to constant weight at 180° C. in a furnace.

### b) Testing of the Gas Permeability

Testing of the gas permeability is carried out using a permeability testing apparatus model PDU from Georg Fischer Aktiengesellschaft, 8201 Schaffhausen, Switzerland.

The test specimen produced as described under (a) is inserted into the precision test specimen tube of the apparatus and the gap between test specimen and test specimen tube is sealed. The test specimen tube is placed in the testing apparatus and the gas permeability index Gp is determined. The gas permeability index Gp indicates the number of cm³ of air which pass through a cube or cylinder having a cross section of 1 cm² at a gauge pressure of 1 cm of water in one minute. The gas permeability index is calculated as follows:

Gp=(Q·h)/(A·p·t)

where:
Gp: gas permeability index
Q: air volume flowing through (2000 cm³);
h: height of the test specimen
A: cross-sectional area of the test specimen (19.63 cm³);
p: pressure in cm of water;
t: time for 2000 cm³ of air to flow through, in minutes.
   p and t are determined; all other values are constants fixed by the testing apparatus.

### Determination of the Specific Surface Area:

The BET surface area is determined in a fully automated nitrogen porosimeter from Micromeritics, model ASAP 2010, in accordance with DIN 66131.

### Pore Volume:

The porosimetry of the pumice is determined by mercury porosimetry in accordance with DIN 66133.

Average Particle Diameter (d₅₀):

The average particle diameter was determined by laser light scattering on a Mastersizer S, Malvern Instruments GmbH, Herrenberg, Germany, in accordance with the manufacturer's instructions.

### Elemental Analysis:

The analysis is based on a total digestion of the materials. After dissolution of the solids, the individual components are analyzed and quantified using conventional specific analytical methods such as ICP.

### Determination of the Density:

The pulverulent porous refractory material is introduced in a single action into a previously weighed 1000 ml glass cylinder which has been cut off at the 1000 ml mark. After the pored cone has been struck off and material adhering to the outside of the cylinder has been removed, the cylinder is weighed again. The increasing weight corresponds to the density.

### EXAMPLE 1

### Formulation for an Exothermic Dry Mix, Inorganically Bonded

| | |
|---|---|
| Reactive aluminum oxide | 8-12% |
| Pumice | 20-30% |
| Chamotte | 8-12% |
| Aluminum powder | 25-29% |
| Magnesium | 2-12% |
| Potassium nitrate | 15-21% |
| Water glass powder | 1-5% |
| Water glass (liquid) | 15-25% |

The ground pumice is placed in a mixer and the other constituents of the mix are added while stirring. The mix can be shaped in customary apparatuses to produce feeders. Curing is effected by blowing hot air into the uncured shaped body.

### EXAMPLE 2

### Insulating Dry Mix

| | |
|---|---|
| Pumice | 80-90% |
| Reactive aluminum oxide | 2-8% |
| Wood flour | 5-15% |
| Water glass (powder) | 8-15% |
| Water | 15-25% |

The ground pumice is placed in a mixer and the water is added. After the pumice has been mixed for about 2 minutes, the other constituents and the solid water glass are added and the mix is stirred further until a homogeneous composition is obtained.

### EXAMPLE 3

### Exothermic Dry Mix, Organically Bonded

| | |
|---|---|
| Reactive aluminum oxide | 10-20% |
| Pumice | 25-35% |
| Chamotte | 5-15% |
| Aluminum powder | 22-28% |
| Magnesium | 2-8% |
| Potassium nitrate | 12-18% |
| Ecocure ® 30 | 10% |
| Ecocure ® 60 | 12% |

The ground pumice is placed in a mixer and the further constituents of the molding composition and also the cold box binders I and II are added while stirring. As cold box binders, it is possible to use conventional binders. In the example, Ecocure® 30, a benzyl ether resin, and Ecocure® 60, a diisocyanate, are used. These cold box binders are marketed by Ashland-Südchemie-Kernfest GmbH, Hilden, Germany. The cold box binders are cured by means of an amine as catalyst.

### Insulating Dry Mix, Organically Bonded

| | |
|---|---|
| Pumice | 70-80% |
| Reactive aluminum oxide | 10-20% |
| Chamotte | 8-12% |
| Wood flour | 8-12% |
| Ecocure ® 30 | 8% |
| Ecocure ® 60 | 10% |

The pumice, the reactive alumina, the chamotte, the wood flour are placed in a mixer. The cold box binders I and II are subsequently added and the mixture is kneaded for a further 2 minutes.

1. A molding composition for producing shaped bodies for the foundry industry, such as insulating or exothermic feeders and other filling funnels and feeding elements for casting molds, which comprises
at least 10% by weight of a porous refractory material which has a continuous open pore structure;
a binder for curing the molding composition; and
a proportion of a reactive aluminum oxide having a specific surface area of at least about 0.5 m²/g and an average particle diameter (D₅₀) of from about 0.5 to 8 μm.

2. The molding composition as claimed in claim 1, further comprising a refractory filler.

3. The molding composition as claimed in claim 1, characterized in that the porous refractory material is selected from the group consisting of pumice, expanded shale, pearlite, vermiculite, boiler sand, foamed lava and mixtures thereof.

4. The molding composition as claimed in claim 1, characterized in that the molding composition has a gas permeability index (Gp) of more than 150, measured on a cured test specimen.

5. The molding composition as claimed in claim 2, characterized in that the refractory filler has an SiO₂ content of less than 60% by weight.

6. The molding composition as claimed in claim 2, characterized in that the refractory filler comprises chamotte.

7. The molding composition as claimed in claim 6, characterized in that the proportion of chamotte present in the refractory filler is at least 50% by weight.

8. The molding composition as claimed in claim 6, characterized in that the chamotte is comprised of at least 30% by weight aluminum oxide.

9. The molding composition as claimed in claim 2, characterized in that the proportion of refractory filler, based on the weight of the molding composition, is in the range from 5 to 60% by weight.

10. The molding composition as claimed in claim 1, characterized in that the binder is selected from the group consisting of cold box binders, hot box binders, water glass, and mixtures thereof.

11. The molding composition as claimed in claim 1, wherein the binder comprises a cold box binder selected from the group consisting of phenol-urethane resins which are activated by amines, epoxy-acrylic resins which are activated by SO₂, alkaline phenolic resins which are activated by CO₂ or by methyl formate, water glass which is activated by CO₂, and mixtures thereof.

12. The molding composition as claimed in claim 1, characterized in that the reactive aluminum oxide comprises more than 2% by weight of the molding composition, based on the weight of the molding composition.

13. The molding composition as claimed in claim 1, characterized in that the reactive aluminum oxide has the following properties:
Al₂O₃ content: >90%;
OH group content: <5%;
Specific surface area (BET): 1 to 10 m²/g;
Average particle diameter (d₅₀): 0.5 to 15 μm.

14. The molding composition as claimed in claim 1, characterized in that the porous refractory material has a pore volume of at least 50%.

15. The molding composition as claimed in claim 1, characterized in that the proportion of the porous refractory material present in the molding composition, based on the weight of the molding composition, is at least 15% by weight.

16. The molding composition as claimed in claim 1 further comprising aluminum powder and/or magnesium powder and an oxidant.

17. A process for producing shaped bodies for the foundry industry, in particular feeders and other filling funnels and feeding elements for casting molds, which comprises
introducing the molding composition as claimed in claim 1 into a mold to give an uncured shaped body;
curing the uncured shaped body to give a cured shaped body; and
removing the cured shaped body from the mold.

18. The process as claimed in claim 17, characterized in that the uncured shaped body is cured by heating the uncured shaped body.

19. A shaped body for the foundry industry, in particular a feeder, filling funnel or feeding element for casting molds, obtained by the process as claimed in claim 17.

20. The shaped body as claimed in claim 19, characterized in that the shaped body, has a gas permeability index (Gp) of more than 150.

21. A process for casting a metal casting, which comprises
providing a pattern in a mold box;
attaching at least one shaped body, produced from the molding composition of claim 1 to the pattern;
introducing, compacting and curing the molding composition in the mold box so as to give a casting mold;
removing the casting mold from the mold box;
introducing liquid metal into the casting mold;
cooling of the metal to solidify it and give a metal casting; and
removing the metal casting from the casting mold.

22. The molding composition as claimed in claim 1, characterized in that porous refractory material has a density of less than 0.5 kg/l.
